(19) United States
(12) Patent Application Publication
(10) Pub. No.: US 2010/0246570 A1
(43) Pub. Date: Sep. 30, 2010

(54) COMMUNICATIONS SESSION PREPARATION METHOD AND APPARATUS

(75) Inventors: David L. Chavez, Broomfield, CO (US); Larry J. Hardouin, Broomfield, CO (US)

Correspondence Address: SHERIDAN ROSS P.C., 1560 BROADWAY, SUITE 1200, DENVER, CO, 80202, US

(73) Assignee: AVAYA INC., Basking Ridge, NJ (US)

(21) Appl. No.: 12/722,263

(22) Filed: Mar. 11, 2010

Related U.S. Application Data
(60) Provisional application No. 61/162,869, filed on Mar. 24, 2009.

(51) Int. Cl. H04L 12/66; G06F 15/16; H04M 11/00

(52) U.S. Cl. 370/352; 709/206; 379/93.17

(57) ABSTRACT

Systems and methods for providing contextual information to one or more parties to a communications session are provided. More particularly, context information relevant to a party to a communications session is delivered to another party to the communications session as part of a communications message. In addition to information providing an identification of a party for whom context information is provided, embodiments of the present invention may make use of supplemental information in selecting context information for delivery.

### CROSS-REFERENCE TO RELATED APPLICATIONS

This application claims the benefit of U.S. Provisional Patent Application Ser. No. 61/162,869, filed Mar. 24, 2009, the entire disclosure of which is hereby incorporated herein by reference.

### FIELD

The present invention is generally directed to communications systems, and to the provision of supplemental information related to a party to a communications session.

### BACKGROUND

With the increased volume of communications and communications modalities a person utilizes today, a significant problem exists with regards to integrating the communications. Communications have indeed become quite complicated. Furthermore, complex communications on a single subject may include multiple modalities, such as voice, video, email, Instant Messaging (IM), Short Message Service (SMS) messaging, blogs, social media, and the like.

Given these complexities, it is very difficult for a person to quickly determine the context of a communication unless that person has an incredible memory, which is rare, or the communication is a part of a communication session in which the person has been recently or currently engaged, thereby putting the communication at the top of the person's mind. Failure to quickly determine the context of a communication may result in an awkward communication, lost content, frustration, or worse. In addition, it is useful for a communicant to have information relating to the other communicant. In particular, by having access to information regarding the other communicant, communications can be personalized.

In a contact center environment, smart screen pops are available to enable a customer service agent to be prepared for calls parked in their queue. Contact centers also have the ability to provide agents with whisper announcements and/or the ability to have a side bar session with subject matter experts and/or supervisors. In addition, contact management software can allow information about called or calling parties to be stored in a personalized form. Information about persons may also be available through social network profiles posted to the Internet, and other means. However, all of these capabilities require a user to interface with multiple environments, and often require significant input from the user. Moreover, although contact center or conferencing environments can provide information supplemental to a communications session through an automated or partially automated solution, such capabilities are not available outside of such environments. In addition, even in connection with a contact center, previous solutions have not provided a unified, high fidelity architecture.

### SUMMARY

Embodiments of the present invention are directed to solving these and other problems and disadvantages of the prior art. According to embodiments of the present invention, a first party to a communications session is provided with context information regarding a second party to the communications session. More particularly, context information is provided regarding one party to a communications session to another party of that communications session as part of or associated with a call signal. For example, embodiments of the present invention provide context information regarding a party to a communications session as part of or as an attachment to a session initiation protocol (SIP) message.

In accordance with embodiments of the present invention, an application or context service is provided. The context service is notified of a communications session or an attempt to establish a communications session, and of at least one party to the communications session or attempted communications session. The context service then provides context information, which can comprise information regarding an identified party to the communications session. The context information is included in or associated with a call signaling message. The call signaling message, including the context information inserted by the context service, is then returned to a communication device associated with another party to the communications session.

In accordance with further embodiments of the present invention, methods for providing contextual information related to parties to a communications session are provided. Specifically, in response to receiving information identifying a party to a communications session or an attempted communications session, an application or context service can provide contextual or context information. That context information is delivered to a communications device associated with another party to the communications session or attempted communications session, as part of a call signaling message. For example, in accordance with at least some embodiments of the present invention, context information is provided as part of a SIP message. In accordance with still other embodiments of the present invention, the context information is provided as an attachment to a SIP message. The context information can then be displayed or otherwise output to a party to the communications session using that party's communication endpoint, or a device operating as an adjunct to the communications endpoint.

Additional features and advantages of embodiments of the present invention will become more readily apparent from the following description, particularly when taken together with the accompanying drawings.

### BRIEF DESCRIPTION OF THE DRAWINGS

FIG. 1 is a block diagram depicting a communications system in accordance with at least some embodiments of the present invention;

FIG. 2 is a block diagram depicting a communications server in accordance with embodiments of the present invention;

FIG. 3 depicts the relationship of components within a communications system in accordance with exemplary embodiments of the present invention;

FIG. 4 depicts an exemplary data structure used in accordance with at least some embodiments of the present invention; and

FIG. 5 is a flowchart illustrating aspects of the operation of a system providing contextual information in accordance with embodiments of the present invention.

### DETAILED DESCRIPTION

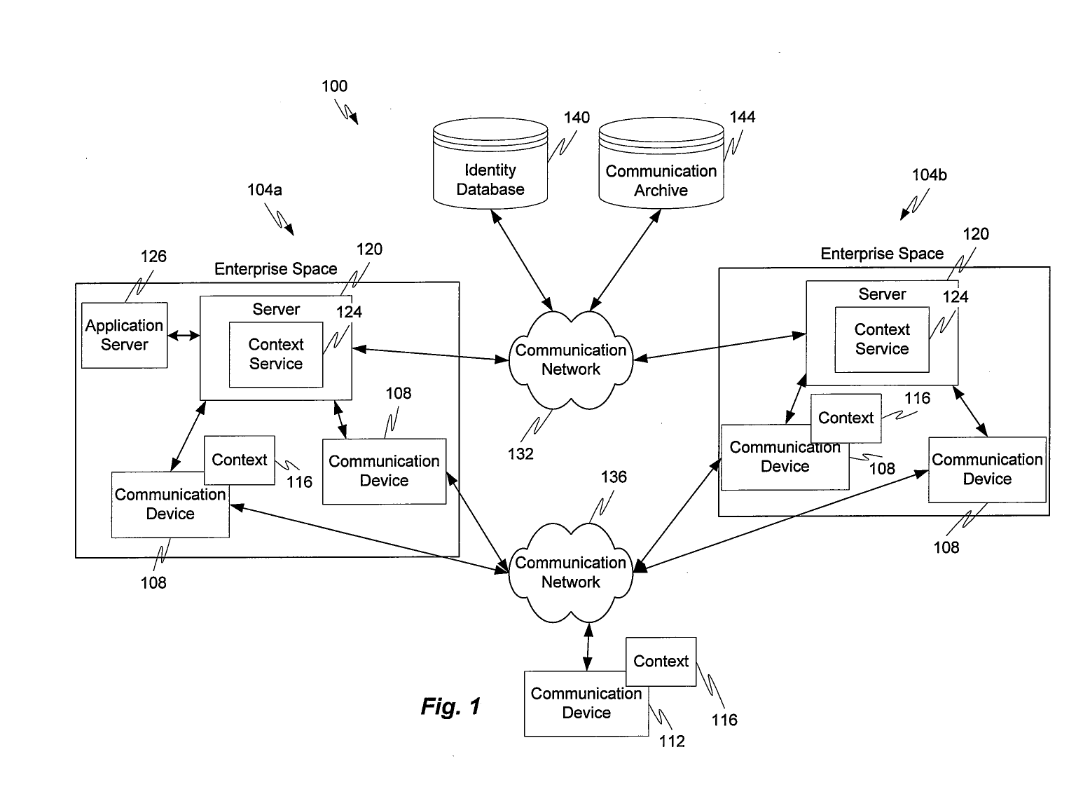

With reference initially to FIG. 1, an exemplary communication system 100 will be described in accordance with at least some embodiments of the present invention. More specifically, the communication system 100 may comprise a plurality of communication devices in communication with one another using a number of possibly different communication modalities. In some embodiments, the communication system 100 includes two or more domains or enterprises 104a, 104b, which are owned and operated by two different entities (e.g., two different companies, enterprises, etc.).

One or both enterprises 104a, 104b may comprise one or more communication devices 108 that allow users in the enterprise to communicate with other users either within the enterprise or with users outside of the enterprise. In particular, the communication devices 108 may be connected to a communication network 136 which facilitates communications with other non-enterprise communication devices 112. Moreover, the communication network 136 may interconnect communication devices 108 in different enterprise domains. The boundaries of the enterprise space 104a, 104b may be defined by network boundary devices, such as Session Border Controllers (SBCs), gateways, or the like.

In some embodiments, the enterprise space 104a, 104b may include dedicated communications equipment or devices, thereby creating a local communication network for the enterprise space 104a, 104b. In particular, the enterprise space 104a, 104b may include a Local Area Network (LAN), a Wide Area Network (WAN), a Session Initiation Protocol (SIP) network, or the like.

The communication network 136 may comprise any type and any number of communication mediums and devices which are capable of supporting communication sessions, such as voice calls, video calls, chats, emails, chats, TTY calls, multimedia sessions, or the like. The communication network 136 may include a LAN, a WAN, a SIP network, and any other type of packet-switched or circuit-switched network known in the art. In addition, it can be appreciated that communication network 136 need not be limited to any one network type, and instead may be comprised of a number of different networks and/or network types. The communication network 136 may include an IP Multi-media Subsystem (IMS) network, an architectural SIP standard well known in the art, or any other type of network which provides access to one or more of the Internet, a standard Plain Old Telephone System (POTS), an Integrated Services Digital Network (ISDN), the Public Switched Telephone Network (PSTN), and any type of known cellular communication network. Accordingly, the communication network 136 is equipped to facilitate communications between communication devices 108 and/or 112 via one or more communication media and/or modalities.

In accordance with at least some embodiments of the present invention, and in an effort to make communications between the communication devices 108, 112 more efficient and user-friendly, a context service 124 may be provided and made available to one or more of the communication devices 108, 112. The context service 124 may comprise an application running on or executed by a server that provides context. In some embodiments, the context service 124 may be provided on a server or communications server 120 maintained within the enterprise space 104a and/or 104b. The context service 124 may also be provided by or in association with an application server 126 that is in communication with the server 120. In some embodiments, the context service 124 may be provided on a server external to any particular enterprise 104a, 104b utilizing its services. In such an embodiment, the context service 124 or content available to the context service may be provided as Software as a Service (SaaS), as an application which leverages cloud computing, or any other software application made available to users on either a subscription basis or paid for according to use. Thus, the context service 124 may be administered by a single enterprise for use by the enterprise communication devices 108 or may be administered by a service provider for use by multiple communication devices 108, 112.

In some embodiments, the context service 124 may be provided within a communications server, such as a Microsoft® Exchange Server, as a thick client or routine for use by the server. In further embodiments, the context service 124 may be made available for use via a web interface or the like. The format in which the context service 124 is provided may vary depending upon system constraints and customer needs without departing from the scope of the present invention.

In accordance with at least some embodiments of the present invention, the context service 124 may be adapted to search sources of contextual information, such as an identity database 140 and/or communication archive 144, to determine a context or multiple contexts associated with a communication. Such determined contextual information may be included as context 116 in a message or signal comprising the communication itself or as an attachment to the message or signal comprising communication. In addition, context 116 can be provided in any of various formats or communications modalities. For example, context 116 may be provided as a whisper page in a call, as an email sent at the same time as a voice call, as an email explaining a voicemail message included as an attachment to an email, as an IM explaining an SMS message, as an email reporting a blog or social network posting, as text provided on a telephone's native display, or the like. Thus, the context 116 can be provided to a user of the communication device 108, 112 to supplement communications sent to and from the communication device 108, 112. In some embodiments, the context 116 can be displayed to a user before a communication is transmitted (e.g., while a user is composing an email but before the email has been sent). This may allow the user to appropriately construct the communication to reflect the desired context 116. Moreover, the sending user can select which context is provided to the receiving user as a part of composing a communication. This can help the sender and receiver collaborate more efficiently and effectively.

The context service 124 may be capable of searching and retrieving relevant contextual information from the identity database 140 and/or communication archive 144 via a communication network 132. The communication network 132 used by the context service 124 may be separate and distinct from the communication network 136. In some embodiments, however, the context service 124 may utilize the communication network 136 to retrieve contextual information from various contextual sources. The communication network 132 may be similar to communication network 136 in that it is configured to carry data packets in the form of messages between nodes connected to the communication network 136.

In accordance with at least some embodiments of the present invention, sources of contextual information include, but are not limited to, an identity database 140 and a communication archive 144. The identity database 140 may comprise information which allows a user's identity to be mapped to other identities or aliases used by that user. As an example, a user may have a first identity for a first communication modality (e.g., username@enterprise.com for email) and a second identity for a second communication modality (e.g., +13034441234 for voice calls). In accordance with at least some embodiments of the present invention, the multiple identities of a single user may be mapped together within the identity database 140.

In some embodiments the identity database 140 may be maintained within the enterprise space 104a, 104b and in other embodiments the identity database 140 may be maintained outside the enterprise space 104a, 104b by some service provider (e.g., email service provider, voice communications service provider, IM service provider, social network service provider, etc.) which provides communication services to a user. Although only a single identity database 140 is depicted, one skilled in the art will appreciate that multiple identity databases 140 may be accessed and searched by the context service 124 when searching for contextual information.

In some embodiments, contextual information may be retrieved on an as-needed basis by the context service 124. Alternatively, or in addition, the context service 124 may submit a persistent request to the identity database 140 that causes the identity database 140 to push information to the context service 124 when any information is changed for a particular user or group of users. Thus, the context service 124 only has to request contextual information for a particular user once and any subsequent updates within the identity database 140 can be automatically communicated to the context service 124, thereby reducing the number of communications required to retrieve contextual information. Moreover, once contextual information updates are received at the context service 124, the context service may update a context cache as will be described in further detail below.

In some embodiments, the communication archive 144 serves as a source of contextual information by providing communication histories and related data. In some embodiments, the communication archive 144 maintains communication histories and possibly the communications themselves in an archived format. The communication archive 144 may be adapted to archive communications in different media and/or modality. Thus, the communication archive 144 may be media and/or modality agnostic. In some embodiments, however, the communication archive 144 may be capable of archiving only certain types of communications (e.g., one of emails, text messages, voicemails, call history transcripts, call logs, blogs, social network message boards, etc.). In this configuration, multiple communication archives 144 may be provided for each of the different communication media and modalities that a certain user is capable of using.

In accordance with at least some embodiments of the present invention, the communication archives 144 may be identified within the identity database 140, thereby allowing the context service 124 to reduce the number communication archives 144 which are searched for contextual information for a particular user or communication.

Similar to the identity database 140, the communication archive 144 may be maintained within the enterprise space 104a, 104b or external to the enterprise space 104a, 104b. Additionally, the communication archive 144 may be maintained within the server 120 that includes the context service 124, especially if the context service 124 is provided in a communications server such as a Microsoft® Exchange Server. Thus, the communications archive 144 may be local to the context service 124. Alternatively, or in addition, communication archives 144 may be retrieved from communication devices 108, 112 if such devices are capable of maintaining a communications log (e.g., missed call log, outgoing call log, incoming call log, email log, SMS message log, IM log, etc.). This provides the context service 124 multiple locations in which contextual information can be retrieved.

Also similar to the identity database 140, the context service 124 may retrieve desired context information from the communication archive 144 on an as-needed basis. Alternatively, or in addition, the context service 124 may submit a persistent request to the communication archive 144 that causes the identity communication archive 144 to push information to the context service 124 when any information is changed for a particular user or group of users.

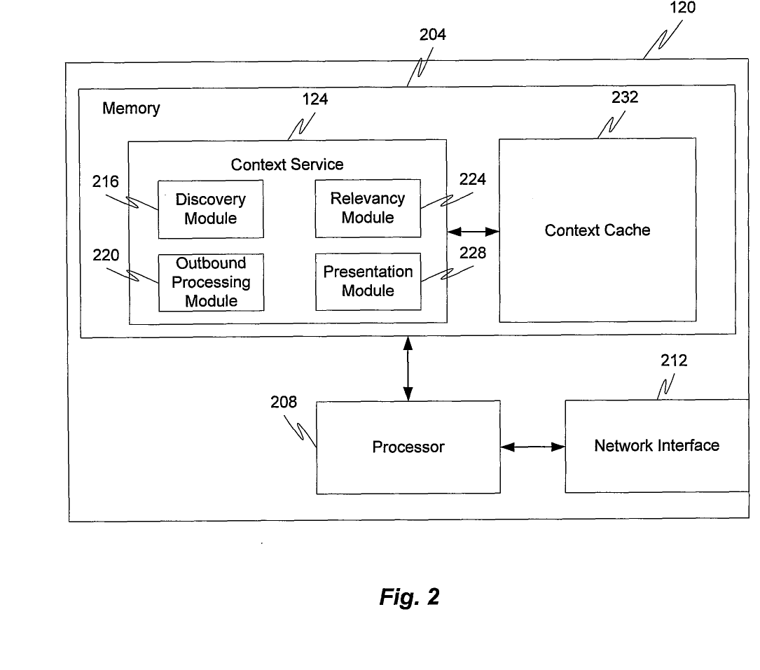

With reference now to FIG. 2, additional details of a communication server 120 providing a context service 124 will be described in accordance with at least some embodiments of the present invention. The context service 124 may be provided as instructions in memory 204 which are executable by a processor 208 co-located with the memory 204. Results of the execution of the context service 124 may be shared with communication devices 108 and/or 112 via the network interface 212. The processor 208 may include any general-purpose programmable processor, digital signal processor (DSP) or controller for executing application programming. Alternatively, the processor 208 may comprise a specially configured Application Specific Integrated Circuit (ASIC).

The network interface 212 may comprise a communication modem, a communication port, or any other type of device adapted to condition packets for transmission across the communication network 132, 136 to a destination communication device as well as condition received packets for processing by the processor 208. Examples of network interfaces 212 include, without limitation, a network interface card, a modem, a wired telephony port, a serial or parallel data port, radio frequency broadcast transceiver, a USB port, or other wired or wireless communication network interfaces.

The memory 204 may be provided for use in connection with the execution of programming by the processor 208, and for the temporary or long term storage of program instructions and/or data, such as the context service 124 and a context cache 232. Alternatively or in addition, data storage may be provided separate from the memory 204. The memory 208 may comprise a solid state memory device. Alternatively or in addition, the memory 208 may comprise a hard disk drive or other random access memory. In accordance with still other embodiments, the memory 208 may provide random access storage and/or read-only storage.

In accordance with at least some embodiments of the present invention, the context service 124 may include one or more modules which are responsible for providing certain features of the context service 124. Examples of such modules include, but are not limited to, a discovery module 216, an outbound processing module 220, a relevancy module 224, and a presentation module 228.

The discovery module 216 may be provided to take sender and/or receiver identity and topic as inputs (among other inputs), generate a filter based on such inputs, and utilize said filter to screen search stored or discovered modes of communications or communication records from the identity database 140 and/or communication archive 144, including but not limited to, email, voice recordings, IM, blogs, microblogs, social media (such as LinkedIn, Facebook, MySpace and the like) and would return relevant search results (i.e., results which met the filter criteria). The discovery module 216 may also operate to search for or filter context information based on the sender identity and/or the receiver identity.

The relevancy module 224 may be provided to score the results obtained from the discovery module 216 for relevance and would allow selective user input and editing for maximum accuracy. The discovery 216 and relevance 224 modules could be run at a time of low device and/or server usage and the results could be stored for use and real time update. Storing a recent result and processing a minimal update in real time would prevent delays experienced by the user from being a detrimental factor in using the system.

The presentation module 228 is generally capable of providing the determined context information in a manner appropriate to the communication device 108, 112 and/or adjuncts to the communication device 108, 112 to which the context information 116 is delivered. The presentation module 228 would also control how verbose the presentation of the context information would be (e.g., less than 100 characters for a desktop application and less than 50 characters for a mobile application) and provide for expansion to the underlying messages in their native format. For example, a brief summary associated with a communication may be initially provided and a more detailed summary or more complete summary may be provided as a click-through (e.g., in response to a user clicking a message or context summary), fly-over (e.g., in response to a cursor passing over a message or context summary), or tab (e.g., as an embedded summary contained within a tab of a communication).

In some embodiments, the outbound processing module 220 is provided to convert the contextual information to a medium (voice, text, video, combination) appropriate to the mode of communications selected by the user. In some embodiments, a multi-media device (e.g., personal computer, laptop, mobile phone, PDA, etc.) may be equipped to render presentation in several media types simultaneously. As one example, if a voice call were incoming, a textual message providing context information could be displayed along with caller identification information. As another example, if an email were received an audible message may be played for a user that describes the associated content of the email. This latter example would be particularly useful in mobile applications, for instance where users are driving their car and receive an email. Other exemplary methods of presenting context information are also possible and will become readily apparent to those skilled in the communication arts based on the present disclosure.

The contents of the context service 124 allow the context service 124 to search local and server based communications logs, sent folders, topical folders, contact databases, social network postings, blogs/microblogs, and the like by sending or receiving party and in turn structures the search based on a particular title, topic, subject or the like. It also enables the coherent and succinct rendering of the results of such searches for ease of use by human users of the communication devices 112.

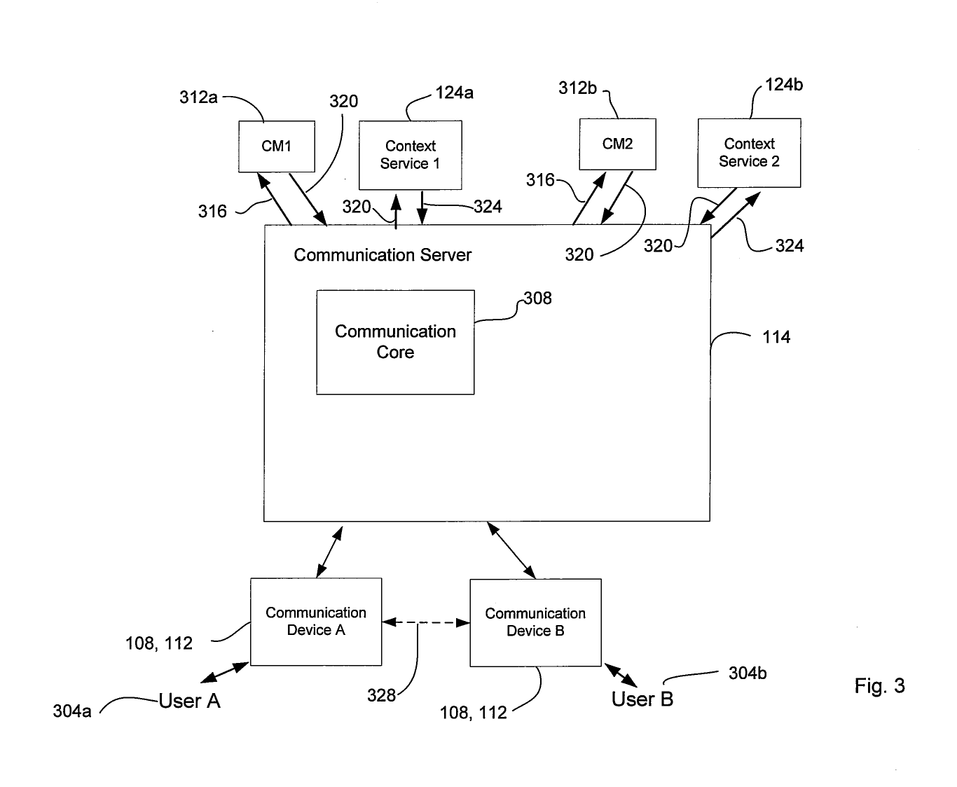

FIG. 3 depicts relationships of components within a communications system 100 between two users or parties 304 in accordance with exemplary embodiments of the present invention. In this exemplary embodiment, communication device A 108, associated with user A 304a, is participating in a call handled by the communications server 120. More particularly, the call may be facilitated by a communication core 308 running on or implemented by the communications server 120. As can be appreciated by one of skill in the art, a communications session may be facilitated by the communication core 308, and by the exchange of call data stream messages. For example, the communication core 308 may implement or reference a communication manager 312, for example in a communications system 100 utilizing the session initiation protocol (SIP), and a SIP invite message 316 can be sent to a first communication manager 312a. The first communication manager 312a can respond with a message 320 comprising a SIP trying message. As can be appreciated by one of skill in the art, a SIP message can include communication data (e.g., voice data), as well as signal or call control data (e.g., an invite message).

In accordance with embodiments of the present invention, a first context service 124a is provided with or otherwise made aware of the communications session that the system 100 is attempting to establish or has established between communication device A 108 and communication device B 112. For example, the SIP response 320 comprising a SIP trying message can be forwarded to the context service 124a. As can be appreciated by one of skill in the art, SIP messages include various items of information. Such information can include addresses identifying a calling communication device A 108, 112 and a called communication device B 108, 112. Accordingly, the SIP message 320 provided to the context service 124 allows the context service 124 to identify communication devices 108, 112 that are or will be party to the communications session or attempted communications session. Using that identifying information, the context service 124 can gather context information. In accordance with embodiments of the present invention, such context information is provided by the context service 124 as part of or as an attachment to a SIP message. Accordingly, a SIP message 324 such as a SIP trying message as well as the context information added by the context service 124a, is returned to the communication core 308. The SIP message 324 including the context information can then be returned to the communication device 108 initiating the call. In this way, user A 304a can be provided with context information regarding user B 304b.

As can also be appreciated by one of skill in the art, the SIP message 316 comprising, in the present example, a SIP invite message, is passed to the system 100 component responsible for handling calls placed to communication device B 108, 112 associated with user B 304b. For example, where communication device A and B 108, 112 are part of the same enterprise space, the first communication manager 312a may handle all segments of the communications session. Alternatively, a second communication manager 312b may be provided with the SIP message 316 used to initiate the communications session. With respect to completing the call to the receiving communication device 108, 112, examples of a SIP message 320 returned by a communication manager 312 may comprise confirmation that all required digits have been received, and/or that the communication device 108, 112 is ringing. Messages related to a communications session or the establishment of a communications session can be passed to a second context service 124b. The context service 124b can then add contextual information 116 to a SIP message. The contextual information thus gathered can then be delivered to a communication device 108, 112 as part of or as an attachment to a SIP message. Accordingly, a second context service 124b can operate alone or in addition to another context service 124.

After user B 304b has answered the call at their communication device 108, 112, and the requisite exchange of SIP messages has been completed, a communications session 328 between communication device A 108 and communication device B 108, 112 is established. Communications data can then be exchanged between the communication devices 108, 112, for example as part of a real time protocol (RTP) data exchange.

In accordance with embodiments of the present invention, contextual information 116 gathered by a context service 124 can pertain to any of the users 304 associated with a communication session 328. The provision of contextual information 116 to a communication device 108, 112 can be performed with respect to one, some, or all communication devices 108, 112 or users 304 participating in a communications session 328. In a typical arrangement, any one communication device 108, 112 that receives contextual information 116 will only receive contextual information 116 regarding another party to the communications session 328. Moreover, even where more than one party to a communications session 328 receives contextual information 116 concerning another party to that communications session 328, such contextual information 116 can be provided by a single communication manager 312 and/or context service 124. In addition, a communications session 328 can be established through the participation of multiple communication servers 120 and/or communication cores 308.

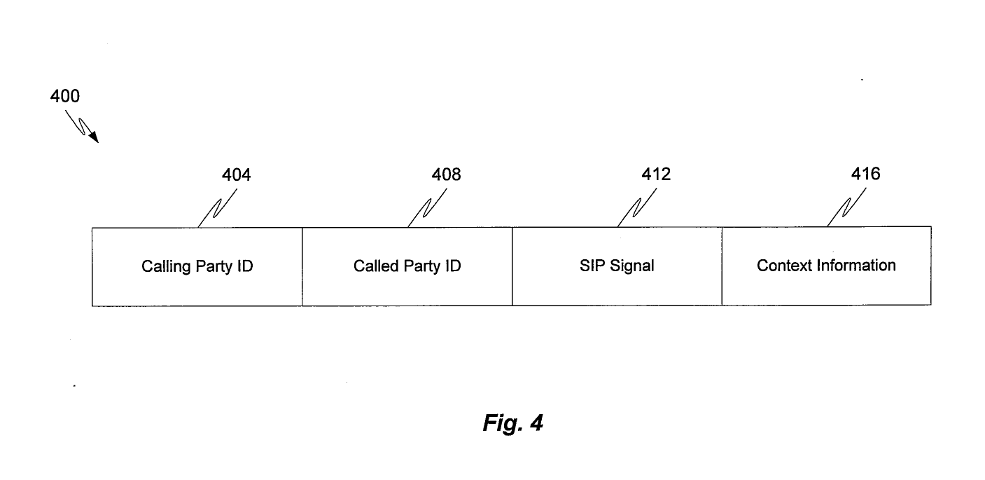

FIG. 4 illustrates an exemplary data structure comprising a call data stream message in accordance with at least some embodiments of the present invention. The data structure comprises a SIP message 400 that generally includes an identification of the calling party 404, an identification of the called party 408, a SIP signal 412, and contextual information 416. The SIP signal 412 can comprise any standard or extended SIP signal or code, such as 100 trying, 180 ringing, 200 ok, etc. The context information 416 comprises the information added by a context service 124. Context information 416 can be in any format, and the particular format that it is provided in can vary based on the capabilities of the communication device that will output the context information to the user. Alternatively or in addition, the context information 416 can comprise an attachment to the SIP message 400.

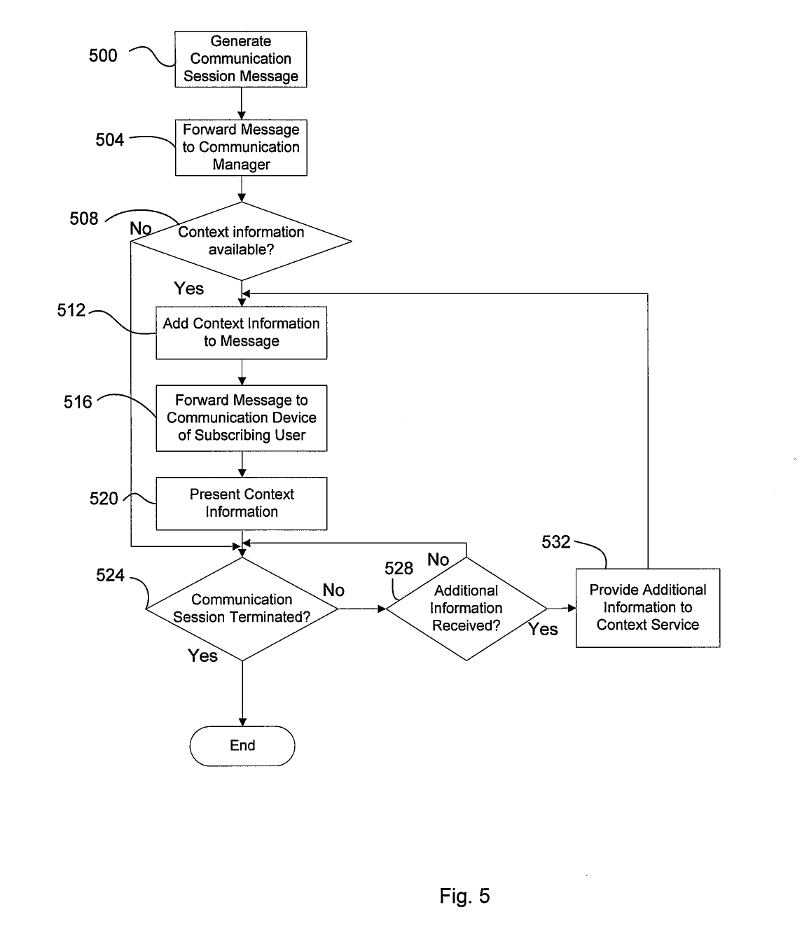

With reference now to FIG. 5, aspects of the operation of a communications system operable to provide context information in accordance with embodiments of the present invention are illustrated. At step 500, a communications session 328 message or call data stream message is generated. This message can include, for example, a request to initiate the communications session 328. As can be appreciated by one of skill in the art, a request to initiate a communications session 328 may originate from a communication device 108, 112. Alternatively, for example in connection with a predictive dialing system, a request for a communications session 328 may be initiated by a server device or automatic dialer. In any case, the request generally results in the generation of a message, such as a SIP invite message, that includes an identification of the communication devices 108, 112 that will serve as endpoints for the requested communications session. In addition, the request for a communications session 328 can include providing a SIP invite message to a communication manager 312 implemented by or associated with a communications server 120.

At step 504, the communications session 328 message, including the identification of the parties to the requested communications session, is forwarded by the communications manager 312 to a context application or service 124. For example, in accordance with embodiments of the present invention, a context application 124 is provided with the SIP invite message, which includes called and calling party addresses. A determination is then made as to whether context information is available (step 508). For example, when a first communication device 108, 112 that has initiated the request for a communications session 328, or that is associated with a dialing system that initiated such a request, subscribes to a context service 124, determining whether context information is available can include determining whether context information 116 regarding the called communication device 108, 112 is available. Alternatively or in addition, determining whether context information is available can include whether context information 116 related to a user 304 associated with a calling communication device 108, 112 is available for delivery to the user 304 associated with the called communication device 108, 112. Determining whether context information 116 is available can also include selecting an appropriate format in which the information is provided. In particular, the context information 116 can be presented to a user in any of various forms. For example, the context information 116 can comprise text that is displayed to the user of a communication device 108, 112 receiving the context information 116. Moreover, such information can be output by a display provided as part of a communication device 108, 112 (e.g., a telephone) itself, or provided as an adjunct to the communication device 108, 112 (for example provided by a general purpose computer operating as an adjunct to a telephone). In accordance with still other embodiments, context information 116 can include information provided in lightweight form, such as a whisper announcement, smart screen pop, or the like. In accordance with still other embodiments, context information 116 can be provided in full content form, such as a MICROSOFT® EXCEL, POWERPOINT, or WORD file. Moreover, the format in which the context information is provided can vary depending on the capabilities of the communication device 108, 112 to which the context information is delivered. Selection of a delivery format can be made by the context application or service 124 in response to information regarding the capabilities of the receiving communication device 108, 112, in accordance with selections made by a user of the receiving communication device 108, 112, or by the receiving communication device 108, 112, itself.

If context information 116 is available, that information is added to the message 400 provided to the context application 124 (step 512). Adding context information to a message can include placing context information into the message itself. For example, context information can be placed within the header of a SIP message, or any other part of a SIP message. As a further example, context information can be provided as an attachment to a SIP message such as a multipurpose Internet mail extension (MIME) attachment.

The message 400, including the added context information 116, is then forwarded or otherwise delivered to the communication device 108, 112 of the subscribing user 304 (step 516). For example, where the context information 116 concerns user A 304a, associated with communication device A 108, 112, the context information can be forwarded to communication device B 108, 112, associated with user B 304b. For instance, the context information may be included in or appended to a SIP invite message. As can be appreciated by one of skill in the art after consideration of the present disclosure, context information 116 can alternatively or additionally be provided to user A 304a, through communication device A 108, 112. For example, context information regarding user B 304b can be delivered to communication device A 108, 112 as part of or as an addendum to a SIP status message, such as a SIP trying or ringing message.

At step 520, the context information that has been added or appended to the message is presented to the user 304 subscribing to the context application or service 124 by the user's communication device 108, 112. For example, textual information can be presented by a native screen display included as part of a communication device 108, 112 comprising a telephone, or by a display provided by a laptop or other general purpose computer comprising a part of a communication device 108, 112 operating as an adjunct to a telephone. As yet another example, textual information can be displayed by a communication device 108, 112 comprising a general purpose computer that supports telephony operations. Alternatively or in addition, context information 116 can be provided in a lightweight form, such as by short messages presented as text, whisper announcements, or the like. Context information 116 can also be provided as full documents or files that are compatible with or that require full applications to view, such as spreadsheets, word processing documents, or databases. Moreover, the particular format in which context information 116 is presented can be selected based on the capabilities of the communication device 108, 112 through which such information will be presented, and/or the preferences of the user 304 associated with the communication device 108, 112.

At step 524, a determination is made as to whether the communications session 328 has been terminated. If the communications session 328 has been terminated, the process may end. If the communications session is ongoing, a determination is made as to whether additional filter or content information is available (step 528). In accordance with embodiments of the present invention, additional filter information can include information regarding the status of a communications session 328, and/or the receipt or discovery of new or updated context information 116. For example, in connection with communications that are conducted according to a script or other structure, additional filter information pertinent to a current or upcoming step within the structured communication can be presented. For instance, a determination can be made as to whether communication flow or status information that can be acted on by a context application or service 124 has been received. If additional filter or context information has been received, that new information is provided the context service 124 (step 532). The process may then return to step 512. The context service 124 may then apply the new information, and additional context information is added at step 512 to a subsequent message for delivery to the communication device 108, 112 associated with a subscribing user 304 (step 516). If it is determined at step 528 that additional filter or context information has not been received, the process may return to step 524.

In accordance with embodiments of the present invention, context information 116 can be provided in sequence, using one or a variety of applications to present the context information to a user 304. Context information 116 is not limited to any particular type. However, in at least some embodiments, the context information 116 includes personal information regarding another user or party 304 to a communications session 328. In addition, context information 116 can include copies of materials that have been annotated by the user 304 provided with such information. Additional examples of applications include presentation tools, spreadsheet tools, documentation tools, project tracking tools, database tools and the like. The personal information that is provided can include the names of family members, names of participants in a prior communications sessions, information about a recent vacation or other event, hobbies, and the like. Materials opened via any of the applications can include personal annotations created by a user 304 when preparing for the communications session 328. An intelligent personal assistant feature can link to the context application 124 to provide whisper announcements, communications sessions progress features, and the like. The context application or service 124 can be part of one or more software programs, hardware components, firmware programs, or the like. Moreover, a context application or service 124 in accordance with embodiments of the present invention can provide coordinated presentation of the context information based on requests by a user 304, automatically, based on an agenda, slide deck, or the like. The context information can be provided to customers of an enterprise telephony system, they can be provided to customers of a communications service provider, they can be provided as a subscription service via a services oriented architecture, a combination of providers, or the like. Depending on the nature of the customer's communication device 108, 112, these features can be provided in client server form, entirely on the communication device 108, 112, entirely on a communications server 120, entirely on an interconnected server, or the like. The communications session 328 can be a traditional telephone call via the PSTN (public switch telephony network), a VoIP (voice-over Internet protocol), a video call, an instant messaging (IM) session, or the like.

In one exemplary embodiment, a user is about to have a telephone conversation from their office with a valued customer. The context application 124 accesses the user's calendar and determines the date, time, phone number, call agenda (if any), materials, personal information associated with the called party, a summary of the last communications session with the same valued customer, and the like, to make it available to the user for the phone call. The context information can be presented on the user's 304 computer screen since the user 304 is in their office. Personal information regarding the called party can be presented at the beginning of the call, such as spouse's name, children's names, their birthdays, hobbies, recent vacations, or the like, to make the communication more personable. If there is an agenda for the call, locating a pointer or the like on the current topic can result in the presentation of information, materials, applications, personal assistant features, or the like associated with that topic. If the telephone conversation runs over and the calling party 304 needs to leave their office, they can transition to an alternate communication device 108, 112, such as their cell phone, via a system like Avaya's EC 500 System, and the Call Preparation System, in response to this change, can provide lightweight screen materials, scroll information across the display, provide whisper announcements, or the like, to provide context information in a format that is appropriate to the party's communication device 108, 112.

In another embodiment, a user may be mobile with an intelligent communication device 308, 312 having a touch screen. A home page of icons for or associated with the context application or server 124 could be presented when the telephone call comprising the communications session 328 is launched. The icons can represent the applications, files, personal information, access to an intelligent personal assistant, or the like. The user (calling party) 304 can trigger launch of each icon when they are ready for it based on their detection of the progress of the call, or these could be presented automatically based on indications entered on an agenda. The ability to have several open applications or files could be handled by toggling back and forth on the intelligent communications device via the touch screen.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for delivering contextual information, comprising:
initiating a first communication session;
in response to initiating the first communication session, identifying at least a second party to the first communication session; and
in response to identifying the second party to the first communication session, delivering information related to the second party to a communication device associated with a first party to the first communication session, wherein delivering information related to the second party to a communication device associated with the first party includes inserting the information in a call data stream message associated with the first communication session.

2. The method of claim 1, wherein the call data stream message is a session initiation protocol message, wherein inserting the information in the call data stream message associated with the first communication session includes associating the information with the session initiation protocol message, wherein the information related to the second party is delivered to the communication device associated with the first party as part of the session initiation protocol message or delivered to the communication device associated with the first party as an attachment to the session initiation protocol message.

3. The method of claim 2, wherein the session initiation protocol message also includes at least one of communication data and call control data.

4. The method of claim 1, wherein the first communication session is initiated by the second party.

5. The method of claim 1, wherein the first communication session includes voice communications, and wherein the information related to the second party is displayed to the first party to the first communication session by the communication device associated with the first party.

6. The method of claim 5, wherein the communication device associated with the first party provides support for voice telephony and a display.

7. The method of claim 5, wherein the communication device associated with the first party includes a telephone operable to support voice telephony and a computer operating as an adjunct to the telephone and providing a display.

8. The method of claim 1, further comprising:
identifying the first party to the first communication session; and
in response to identifying the first party, delivering information related to the first party to a communication device associated with the second party.

9. The method of claim 2, wherein the information related to the second party to the first communication session is associated with the session initiation protocol message by a context service.

10. The method of claim 9, wherein the context service receives the session initiation protocol message identifying the second party to the first communication session, and wherein the context service provides the information related to the second party to the first communication session.

11. The method of claim 2, wherein the information related to the second party is attached to the session initiation protocol message.

12. The method of claim 1, further comprising:
after delivering information related to the second party to the communication device associated with the first party, receiving a first input from the first party;
in response to the first input, delivering additional information related to the second party to the communication device associated with the first party.

13. The method of claim 12, wherein the first input from the first party indicates a status of the communication session.

14. A communication system, comprising:
a first communication device;
a first communication server, wherein the first communication device is interconnected to the first communication server;
a first context application,
wherein in response to a first session initiation protocol (SIP) message related to establishing a first communication session the first communication server provides a SIP message that includes a first SIP signal and that includes information identifying at least one of a called party and a calling party to the first context application,
wherein in response to receiving the information identifying at least one of a called party and a calling party the first context application provides first information related to at least one of the called party and the calling party, and
wherein a second SIP message including a second SIP signal and the first information related to at least one of the called and calling party is delivered to the first communication device.

15. The communication system of claim 14, wherein the first communication device is an initiating communication device, wherein the first SIP signal includes a SIP request, and wherein the second SIP signal includes a SIP response.

16. The communication system of claim 15, further comprising:
a first context server, wherein the first context server is interconnected to the first communication server, and wherein the first context application is executed by the first context server.

17. The communication system of claim 1, wherein the communication server includes a communication core.

18. A system, including:
a communication manager;
a context application running on a processor included in a server in association with memory, wherein a first SIP message is forwarded to the context application by the communication core, wherein the context application identifies context information based on information contained in the first SIP message, wherein the identified context information is added to the first SIP message to create a second SIP message, wherein the second SIP message is provided to a communication device, and wherein the communication device presents the identified context information to a user.

19. The system of claim 18, further comprising:
a communications server, wherein the communication manager is running on the communication server.

20. The system of claim 19, further comprising:
a context server, wherein the processor the context application is running on is included in the context server.
